(19) United States
(12) Patent Application Publication
(10) Pub. No.: US 2003/0188469 A1
(43) Pub. Date: Oct. 9, 2003

(54) Removable apparel advertsing panels and method of use

(76) Inventor: Joey Torres, Las Vegas, NV (US)

Correspondence Address: QUIRK & TRATOS, 3773 HOWARD HUGHES PARKWAY, SUITE 500 NORTH, LAS VEGAS, NV, 89109, US

(21) Appl. No.: 10/117,268

(22) Filed: Apr. 5, 2002

(51) Int. Cl. G09F 21/02

(52) U.S. Cl. 40/586

(57) ABSTRACT

The present invention relates to a means for attaching a plurality of cloth-like front and rear panels, having advertisements depicted thereon, to an athlete's uniform or equipment. For example, the panels can be attached to a waistband of boxing trunks. Attachment of the panels to the waistband is preferably accomplished by means of hook and loop fastener material. The plurality of panels, each preferably having a unique advertisement thereon, are all attached, in a staggered fashion, prior to a fight. Once the first round ends, a first front and rear panel is removed to reveal a second front and rear panel depicting new advertisements. In this fashion, twenty-four unique advertisements may be displayed during a single 12-round fight. Such advertising panels can be implemented into any sporting event assuming the rules of the particular sport provide for such nonessential equipment.

### FIELD OF INVENTION

This invention is generally related to sports apparel and methods of placing advertisements thereon. More particularly, removable layers of cloth-like panels, having advertisements depicted thereon, are attached to sports apparel or equipment. The layers can be routinely removed to present a new advertisement to a live audience as well as a television viewing audience.

### DESCRIPTION OF THE PRIOR ART

Advertising is a multi-billion dollar industry used by entities and individuals worldwide to promote products and services. Advertisements are disseminated in nearly every conceivable fashion including on television, in magazines, in newspapers, on internet based websites, atop taxi-cabs, across blimps, on billboards, etc. The popularity of college and professional sports have caused advertisers to seek methods for promoting entities, individuals, goods and/or services to the semi-captive sports-viewing audience. To that end, commercials aired during the Super Bowl now cost approximately $2,000,000 per thirty second spot.

Two types of advertisements related to sporting events have come to the forefront. First, television commercials seek to attract the television-viewing audience during breaks in a sporting event. While such commercials can be successful, they do have their drawbacks. Television spots are highly expensive as set forth above. Moreover, many viewers, with the use of remote controls, immediately turn the channel during commercials in an effort to locate another sporting event airing simultaneously on another channel. Commercials are also an opportune time to take a restroom or meal break. Therefore, many sports enthusiasts rarely watch the expensive television commercials. Second, advertisers have devised schemes for targeting live audiences. Every square inch of available space at ballparks and stadiums are covered with advertisements in a graffiti-like fashion. The teams' owners even generate millions from naming the ballparks and stadiums after corporate conglomerates (e.g. PacBell, Enron, etc.). However, even though the stadium advertising is beneficial, the size of the live audience attending sporting events pales in comparison to those tuning in via television.

Therefore, the need exists for a method of advertising during a sporting event that successfully targets both the live audience and the television-viewing audience. Recently, advertisers have implemented two methods for advertising during sporting events which have met with controversy, but continue to be extremely popular. One television network has begun selling digital advertising space behind the batter's box during televised Major League Baseball games. The banner ad is digitally created and positioned in a television viewable area behind the batter, catcher and umpire. However, the live audience is not privy to the digitally created advertisements, but the digital images are shown during play of the game thereby eliminating the circumstance of commercials, aired during breaks in the action, not being viewed. A more recent advertisement campaign has been utilized during boxing matches. Advertisers have placed temporary tattoos displaying entities, individuals, goods and/or services on the boxers' bare backs. Such tattoos are viewable by both the live audience and the television-viewing audience. One drawback with the temporary tattoos is that the advertisements are limited to one per boxer per boxing match (i.e. two ads per match).

The present invention overcomes the drawbacks associated with the aforementioned advertising methods. By providing successive unique removable layers of cloth-like panels, depicting advertisements thereon, athletes can be used to promote a plurality of entities, individuals, goods and/or services during a single sporting event. While any sporting event can be the basis for implementing the present invention, the detailed description herein is limited, for the sake of brevity, to the sport of boxing.

Boxing trunks include a waistband of sufficient thickness to provide means for attaching a plurality of removable layers of cloth-like panels having unique advertisements thereon. The panels are preferably nylon but any flexible material is suitable. Preferably hook and loop fasteners are strategically placed on both front and rear surfaces of the waistband corresponding to hook and loop fasteners placed on the plurality of cloth-like panels. The panels are removably attached to the waistband in a staggered arrangement allowing each successive outer layer to be removed without disturbing the sub-adjacent layers. Conceivably, assuming one front and one rear advertisement per round, twenty-four unique advertisements can be shown during a 12-round fight. Several U.S. Patents disclose the use of hook and loop fasteners for attaching towels or the like to an article of clothing. Typically the article of clothing is related to a sporting activity and the towel is used to wipe away perspiration. However, the patents do not disclose the use of a plurality of successively arranged cloth-like panels having advertisements depicted thereon.

For example, U.S. Pat. No. 4,768,236 (the '236 patent) to Klob discloses a detachable toweling means. The '236 patent describes a toweling means attached to a pair of shorts by means of Velcro®. By way of further example, U.S. Pat. No. 5,029,343 (the '343 patent) to McIntyre describes a towel-like appendage attached to a shirt. According to the specification, the towel-like appendage is preferably attached at one of its end proximate the neck opening on the back of a shirt.

None of the noted references suggest or teach the use of multiple layers of panels having advertisements depicted thereon.

### SUMMARY OF THE INVENTION

An object of the present invention is to provide a method for targeting both a live audience and a television-viewing audience with advertisements.

Another object of the present invention is to provide a method for displaying a plurality of unique advertisements during a single sporting event.

Another object of the present invention is to provide an inexpensive method of advertising through the medium of television.

A further object is to provide a plurality of cloth-like panels removably wearable by athletes, preferably boxers, but not limited thereto, during competition.

Accordingly, boxing trunks, more particularly the waistband and legs of the trunks, are retrofitted with one or more sections of hook and loop fasteners. The sections are on both the front and rear surfaces of the waistband. A plurality of cloth-like panels are formed in a size akin to a loin cloth. Each panel is fitted with hook and loop fastener material providing a means for attachment to the waistband's hook and loop fasteners. Preferably, two unique advertisements are shown per round of the fight. One advertisement is depicted on a first front panel adjacent the boxer's lower abdominal and thigh area and a first rear advertisement is depicted on a rear panel adjacent the boxer's behind. Once the first round ends, the first front panel and the first rear panel are removed to display a second front panel and a second rear panel. This continues until the rounds, or the fight ends. In other words, all advertising panels are attached prior to a fight so that it is a simple process to remove them as the fight progresses.

To facilitate non-interfering attachment of the panels, preferably the panels are attached in a staggered fashion such that the sections of the hook and loop fasteners of the final front and rear panels are attached at a lower most point of the hook and loop fastener material retrofitted to the waistband and along the legs of the trunks. Each successive panel is then attached in an overlapping fashion over the previous panel and attached to a higher point of the hook and loop fastener material of the waistband.

Other objects, features, and advantages of the invention will become apparent to those skilled in the art upon consideration of the following detailed description of the preferred embodiments thereof as illustrated in the accompanying drawings.

### BRIEF DESCRIPTION OF THE DRAWINGS

FIG. 1 is a front view of a boxing trunks with a first front panel depicting an advertisement thereon;

FIG. 2 is a side view of the boxing trunks with a plurality of front and rear panels shown in an exploded fashion for clarity;

FIG. 3 is a front view of the boxing trunks of FIG. 1 showing the first front panel detached and the second front panel depicting a unique advertisement thereon;

FIG. 4a is a front view of the boxing trunks with all front panels removed showing the panel attachment means;

FIG. 4b is a rear view of the boxing trunks with all rear panels removed showing the panel attachment means; and

FIG. 5 is a rear view of a representative panel showing the panel attachment means.

### DESCRIPTION OF THE EMBODIMENTS

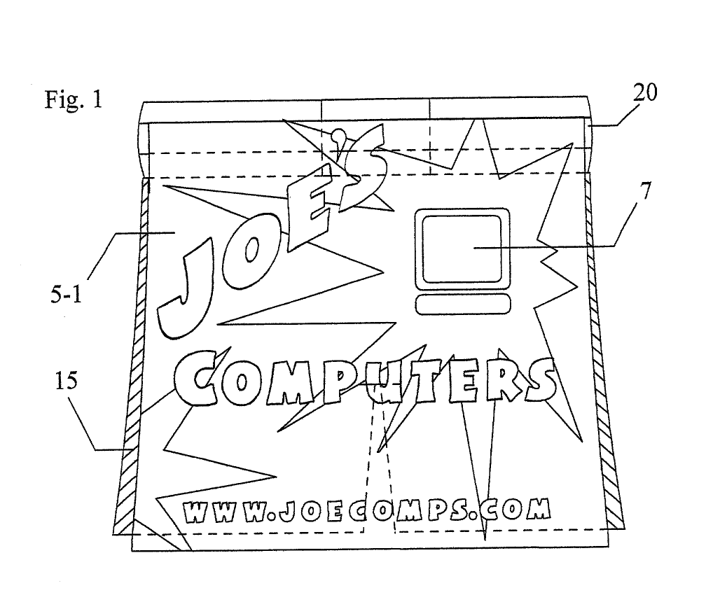

Reference is now made to the figures wherein like parts are referred to by like numerals throughout. Referring to FIG. 1, a first cloth-like front panel 5-1, of a plurality of panels 5-n, is illustrated with an advertisement 7 for Joe's Computer Co. The cloth-like panel 5-1 covers a majority of a front section of a pair of conventional boxing trunks 15 having a waistband 20 (both trunks and waistband shown partially with dotted lines). The size of front panels 5-1 through 5-n is only limited by rules of boxing and a boxer's comfort level. Therefore, the panels 5-1 through 5-n can be smaller or larger than shown depending on the specific rules and the particular boxer. The panels 5-1 through 5-n and a plurality of rear panels 10-1 through 10-n are preferably fabricated of nylon but any flexible material is suitable.

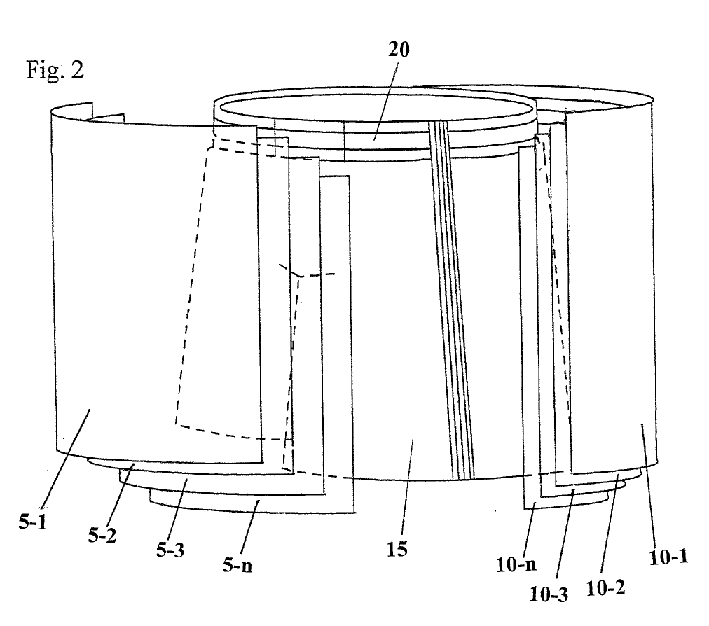

Now referring to FIG. 2, both the plurality of front panels 5-1 through 5-n and the plurality of rear panels 10-1 through 10-n are shown in an exploded fashion to more clearly illustrate the relationship between the plurality of panels. The number of front panels 5-1 through 5-n and rear panels 10-1 through 10-n is preferably equal to the number of scheduled fight rounds, but the number is wholly arbitrary in practice. Preferably, the panels 5-1 through 5-n and 10-1 through 10-n are each attached prior to the start of the fight. Alternatively, and less preferably, the front panels 5-1 through 5-n and the rear panels 10-1 through 10-n can be attached one per round and switched during round breaks.

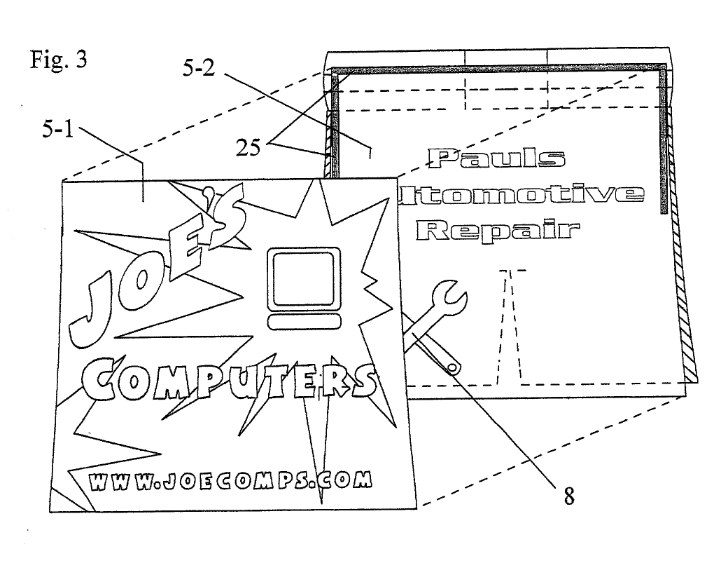

FIG. 3 illustrates the first front panel 5-1, clearly shown in FIG. 1, detached and the second front panel 5-2 now displayed with a second unique advertisement 8 for Paul's Automotive Repair. The section of hook and loop fastener material 25 on the waistband 20 in now visible. As the panels 5-1 through 5-n are removed, the visible section of hook and loop fastener material 25 on the waistband 20 and along the legs of the trunks 15 is revealed given the preferably staggered fashion of attaching the panels 5-1 through 5-n and 10-1 through 10-n. Although the hook and loop fastener material 25 on the waistband 20 and along the legs of the trunks 15 is shown as a single wide band, it can just as easily be replaced with multiple parallel vertical and horizontal sections, strategically placed square pieces and so forth as long as the sections of hook and loop material 25 allow the multiple panels 5-1 through 5-n and 10-1 through 10-n to be attached in a preferably staggered fashion.

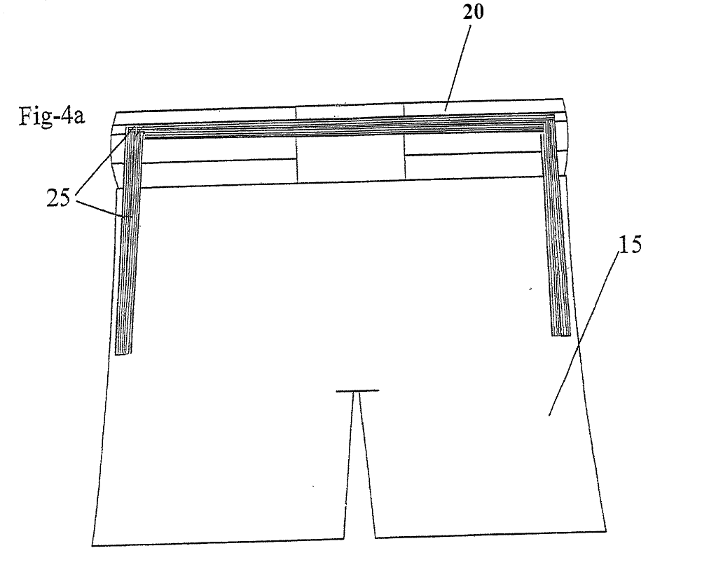

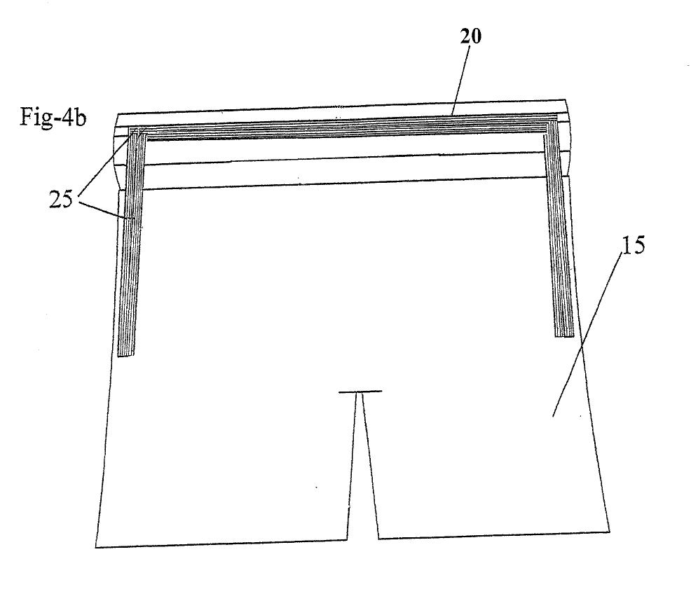

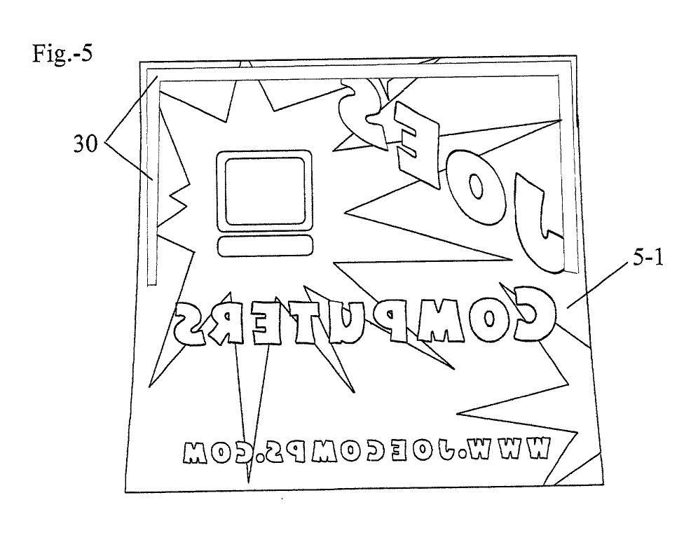

FIG. 4a shows the hook and loop fastener material 25 with all front panels 5-1 through 5-n removed revealing the hook and loop fastener material 25 for attaching the front panels 5-1 through 5-n. FIG. 4b shows the rear of the boxing trunks 15 with all rear panels 10-1 through 10-n removed revealing the hook and loop fastener material 25 for attaching the rear panels 10-1 through 10-n. FIG. 5 shows the rear of a representative panel 5-1 through 5-n, or 10-1 through 10-n, having a section of hook and loop material 30 integrated thereon. Again, the hook and loop fastener material 30 can take numerous forms and patterns so long as it allows for the panels to be removably attached to the boxing trunks 15, namely to the hook and loop fasteners 25 on the waistband 20 and along the legs of the trunks 15.

The hook and loop fastener material along the legs of the trunks 15, namely the thigh areas, prevents the panels from flapping uncontrollably during the fight. This arrangement provides that the current panel advertisements, front and rear, will be continuously visible to the audience during the fight round.

Although the present invention has been described in detail as it relates to boxing, the present invention can be implemented in any sports environment. For example, tennis players may be outfitted with the advertising panels which could be removed between games.

Although the invention has been described in detail with reference to a preferred embodiment, additional variations and modifications exist within the scope and spirit of the invention as described and defined in the following claims. For example, the panels 5-1 through 5-n and 10-1 through 10-n may be attached to the boxing trunks at points other than the waistband 20 and may use attachment means other than hook and loop fasteners (e.g. snaps, tear-away material, etc.).

I claim:

1. Advertising panels for use during a sporting event including:
a plurality of panels having an advertisement depicted thereon; and
means for removably attaching the plurality of said panels to an athlete's apparel or equipment, said plurality of panels arranged in overlapping succession such that a first panel is initially revealed, a second successive panel being revealed when the first panel is removed, each successive panel being revealed accordingly.

2. The advertising panels of claim 1 wherein said means for removably attaching said plurality of panels is hook and loop fasteners secured to one or more sections of said apparel or equipment and corresponding hook and loop fasteners secured to one or more sections of each of the plurality of panels.

3. The advertising panels of claim 2 wherein each of said successive panels is attached to the apparel or equipment in a vertically staggered arrangement.

4. The advertising panels of claim 1 wherein said apparel or equipment is boxing trunks.

5. The advertising panels of claim 4 wherein said means for removably attaching said plurality of panels is hook and loop fasteners secured to one or more sections of said trunks and corresponding hook and loop fasteners secured to one or more sections of each of the plurality of panels.

6. The advertising panels of claim 5 wherein each of said successive panels is attached to the trunks in a vertically staggered arrangement.

7. The advertising panels of claim 5 wherein a first plurality of panels are secured to a front area of a waistband of the boxer's trunks and a second plurality are secured to a rear area of the waistband.

8. The advertising panels of claim 7 wherein each of said first plurality of panels and each of said second plurality of panels is attached to the waistband in a vertically staggered arrangement.

9. The advertising panels of claim 4 wherein said panels are fabricated of nylon.

10. An article of sports apparel or equipment in combination with advertising panels including:
a plurality of panels having an advertisement depicted thereon; and
means for removably attaching the plurality of said panels to said sports apparel or equipment, said plurality of panels arranged in overlapping succession such that a first panel is initially revealed, a second successive panel being revealed when the first panel is removed, each successive panel being revealed accordingly.

11. The combination of claim 10 wherein said means for removably attaching said plurality of panels is hook and loop fasteners secured to one or more sections of said apparel or equipment and corresponding hook and loop fasteners secured to one or more sections of each of the plurality of panels.

12. The combination of claim 11 wherein each of said successive panels is attached to the apparel or equipment in a vertically staggered arrangement.

13. The combination of claim 10 wherein said sports apparel or equipment is boxing trunks.

14. The combination of claim 13 wherein each of said successive panels is attached to the trunks in a vertically staggered arrangement.

15. The combination of claim 14 wherein said means for removably attaching said plurality of panels is hook and loop fasteners secured to one or more sections of said trunks and corresponding hook and loop fasteners secured to one or more sections of each of the plurality of panels.

16. The combination of claim 15 wherein a first plurality of panels are secured to a front area of a waistband of the boxer's trunks and a second plurality are secured to a rear area of the waistband.

17. The combination of claim 16 wherein each of said first plurality of panels and each of said second plurality of panels is attached to the waistband in a vertically staggered arrangement.

18. The combination of claim 13 wherein said panels are fabricated of nylon.

19. A method of advertising during a live sporting event including:
providing a plurality of panels depicting advertisements thereon;
providing means for removably attaching said plurality of panels to an athlete's apparel or equipment, said plurality of panels arranged in overlapping succession such that a first panel is initially revealed; and
removing said first panel to reveal a second successive panel, each successive panel being revealed accordingly.

20. The method of claim 19 wherein said means for removably attaching said plurality of panels is hook and loop fasteners secured to one or more sections of said apparel or equipment and corresponding hook and loop fasteners secured to one or more sections of each of the plurality of panels.

21. The method of claim 20 wherein each of said successive panels is attached to the apparel or equipment in a vertically staggered arrangement.

22. The method of claim 19 wherein said sports apparel or equipment is boxing trunks.

23. The method of claim 22 wherein each of said successive panels is attached to the trunks in a vertically staggered arrangement.

24. The method of claim 23 wherein said means for removably attaching said plurality of panels is hook and loop fasteners secured to one or more sections of said trunks and corresponding hook and loop fasteners secured to one or more sections of each of the plurality of panels.

25. The method of claim 24 wherein a first plurality of panels are secured to a front area of a waistband of the boxer's trunks and a second plurality are secured to a rear area of the waistband.

26. The method of claim 25 wherein each of said first plurality of panels and each of said second plurality of panels is attached to the waistband in a vertically staggered arrangement.

27. The method of claim 22 wherein said panels are fabricated of nylon.
